(19) United States
(12) Patent Application Publication
(10) Pub. No.: US 2003/0101291 A1
(43) Pub. Date: May 29, 2003

(54) Application programming interface for provision of DICOM services

(76) Inventors: Christopher Joseph Mussack, Waukesha, WI (US); John David Hoford, Pewaukee, WI (US); Phani Kumar Bidarahalli, Waukesha, WI (US)

Correspondence Address: OSTRAGER CHONG & FLAHERTY LLP, 825 THIRD AVE, 30TH FLOOR, NEW YORK, NY, 10022-7519, US

(21) Appl. No.: 09/683,624

(22) Filed: Jan. 28, 2002

Related U.S. Application Data
(60) Provisional application No. 60/333,108, filed on Nov. 23, 2001.

(51) Int. Cl. G06F 9/00; G06F 15/16

(52) U.S. Cl. 709/328; 709/201

(57) ABSTRACT

An application programming interface (API) for enabling a business layer of a tiered DICOM application to talk to different implementations of a data management layer. The invention has particular application in a PACS view station. In particular, the invention is directed to an API that forms the seam between a business layer that requests DICOM service by synchronous messaging and a data management layer that passes on those requests to the service provider by asynchronous messaging. Thus, an application developer need not write code for the business layer that accounts for the DICOM callback mechanism, which confirms completion of a requested DICOM service. Instead the data management implementation, which is hidden from the user, handles the callback mechanism so that responses to requests for DICOM service appear instantaneous to the user.

### CROSS REFERENCE TO RELATED APPLICATIONS

This application claims the benefit, under Title 35, United States Code, §119(e), of U.S. Provisional Application No. 60/333,108 filed on Nov. 23, 2001.

### BACKGROUND OF INVENTION

This invention relates generally to diagnostic medical imaging and more particularly, to applications for providing DICOM (Digital Imaging and Communications in Medicine) services. To be even more specific, the invention relates to the data management level in a tiered application that requires DICOM services.

Modern hospitals and diagnostic clinics use medical imaging workstations to access digital medical images derived from a variety of imaging modalities. Multiple imagery source devices may be connected via hospital information networks to hospital devices such as viewing workstations, film printers, or optical storage devices. Hospitals typically use a Picture Archival and Communication System (PACS) to import and manipulate imagery. To facilitate the medical professional's use of the PACS and to reduce associated costs, the DICOM standard was developed.

DICOM provides standardized formats for images, a common information model, application service definitions, and a protocol for communication. DICOM is based upon the Open System Interconnect (OSI) reference model, which defines a seven-layer protocol. The DICOM standard is an industry-wide standard, well known to those of skill in the art. In the OSI context, DICOM is an “application level” standard, i.e., DICOM is implemented in the seventh or uppermost layer. This layer supports application and end-user processes. Communication partners are identified, quality of service is identified, user authentication and privacy are considered, and any constraints on data syntax are identified. Everything in this layer is application-specific.

Tiered application architectures are part of the application layer. A tiered application architecture provides a model for developers to create a flexible and reuseable application. By breaking up an application into tiers or layers (in the context of discussing application layers, the terms “tier” and “layer” are used synonymously herein), application developers only need to modify or add a specific layer, rather than need to rewrite the entire application when changes are made.

A typical tiered application comprises a graphical user interface (GUI), a presentation logic tier that provides an interface for the end user into the application, a business tier containing the business rules, data manipulation, and so forth, and a data management layer for storing and retrieving information. The data management layer may be a complex and comprehensive product including query optimization, indexing, etc., or simple plain text files (and the engine to read and search these files) or something in between. Optionally, the tiered application may include a data access layer containing generic methods that provide a reusable interface to the database.

Central to DICOM is a hierarchy of object types. An Information Object Definition (IOD) is an object-oriented abstract data model used to specify information about Real-World Objects. An IOD provides communicating Application Entities with a common view of the information to be exchanged. An IOD does not represent a specific instance of a Real-World Object, but rather a class of Real-World Objects that share the same properties. An IOD that includes information about related Real-World Objects is called a Composite Information Object. A Composite IOD contains one or more Information Entity objects. An Information Entity is that portion of information defined by a Composite IOD that is related to one specific class of Real-World Object. An Information Entity object contains one or more Module objects. A Module object contains a series of related Attribute objects. An Attribute object consists of an encoded name (i.e., tag) and value. For storage and transmission purposes, data is transmitted as IODs or Composite IODs.

DICOM attribute information may include patient attributes (e.g., patient name and patient identification number), exam attributes (e.g., exam description and exam date), series attributes (e.g., modality type and series date), and image attributes (e.g., image type and numbers of rows and columns). Each attribute has a name, a value representation and a tag. A tag is a number unique to the attribute, e.g., (0040,0100), and is used to identify the attribute. (Different systems use different tags for the same attribute name, which gives rise to incompatibility, as described in more detail hereinafter.) The value representation defines what type of value the attribute can have (e.g., a 64-character string, binary data, etc.).

The DICOM standard specifies certain services and a protocol for the provision of those services to PACS users. DICOM, however, does not provide applications to provided DICOM service. Application development is left to the imagination and determination of system designers and application programmers, who must create, develop, implement (write code), and debug thousands of lines of computer code to develop applications that provide DICOM services and conform to the DICOM standard protocol.

With respect to generating, processing, and displaying medical images, the development of medical imaging applications generally requires significant software development effort. The development is usually performed by highly skilled software practitioners since specialized software skills are needed to develop graphical user interface (GUI) based medical imaging applications.

Known medical imaging systems have a client-server architecture. A major advantage of this architecture is that the application process can remain attentive to the user because the application does very little processing. Most processing is handled by servers. The servers, in turn, are “specialists” at providing a particular service and may in fact be running on specialized hardware, optimized for particular tasks. A good example of this specialization is a processing server for providing a DICOM service to a user. The ability to access network distributed resources is a major advantage of the client-server architecture. The present invention relates to an application programming interface for providing DICOM service from a database, an archive, a networked object, etc.

Since the invention employs object-oriented programming (OOP), a basic understanding of OOP is required. Object-oriented programming languages associate an object's data with programmed methods for operating on that object's data. Usually, OOP objects are instantiated in a memory area and are based on classes that reference the programmed-methods for the OOP object. Instantiated OOP objects contain data (in instance variables) specific to that particular instantiated OOP object. Conceptually, an OOP object contains object-related information (such as the number of instance variables in the object), the instance variables, and addresses of programmed-methods that access and/or manipulate the contents of the instance variables in the object. However, because objects often share programmed-methods and object-related information, this shared information is usually extracted into a class. Thus, the instantiated object simply contains its instance variables and a pointer to its class.

In object-oriented design, an interface is a collection of operations that are used to specify a service of a class or component. Such an interface defines a line between the specification of what an abstraction does and the implementation of how that abstraction does it. Interfaces are used to model the seams in a system composed of software components. An interface specifies a contract for a class or component without dictating its implementation. A method is the implementation of an operation. A class may realize an interface by providing a set of methods that properly implement the operations defined in the interface.

In particular, an Application Programming Interface (API), as used herein, is a collection of operations used to specify a service of a class or component by which a programmer writing an application program can make requests of the operating system or another application. The API can be implemented as an object-oriented framework or a procedural library. It is known to provide an API that a software programmer can utilize in building software applications that employ DICOM standard services. U.S. Pat. No. 5,668,998 discloses an API for object-oriented mapping the DICOM standard services menu onto a framework of service interface objects that perform a selected DICOM service within or between PACS networks. In accordance with the teaching of U.S. Pat. No. 5,668,998, each service interface object encapsulates the functions necessary to perform the particular DICOM service that it represents. An instantiation of a service interface object creates a unique relationship between the instantiated service interface object and a particular Service Class Provider (SCP) and Service Class User (SCU) pair. The SCU/SCP pair ensures that messages and events are in appropriate DICOM standard format in conformance with the DICOM standard protocol.

The DICOM standard protocol employs a callback mechanism by which the target object of a message returns the result of the message by initiating a second message, whose target object is the sender of the original message. More specifically, a sender object sends an asynchronous message to a target object requesting a DICOM service. The sender object also supplies its handle (a handle is the implementation of an object identifier), which will provide the return address for later callback. The operation of the sender object that sent the asynchronous message continues executing for a while and then terminates. When the invoked operation of the target object has completed its job, the target object sends an asynchronous callback message to the sender object confirming job completion.

With respect to DICOM task execution in a client-server architecture, the application makes a request for some DICOM service. Because the server that processes the request can reside anywhere on a local area network, the application must wait for the operation to complete before reporting the results back to the user. The amount of time the application must wait depends on many factors, including the speed of the server. To remain interactive, the application must yield, which typically is performed by returning the execution thread to the idle state so that the application can respond to other user requests. When the reply from the previously queued request arrives, the application must then restore the processing context of the application to its prerequest state and present the results of the operation. This process is commonly referred to as asynchronous behavior.

Experience has shown that implementation of the request-yield-reply paradigm introduces significant programming obfuscation because single operations must be broken up into multiple execution threads, state or context information must be managed to bind the request side to the reply side, and subtle, difficult to diagnose timing related errors can creep into the code due to multiple interactive asynchronous execution threads. The resulting code also is difficult to maintain. These factors have significantly reduced the productivity of programmers in the DICOM environment.

Moreover, the asynchronous execution application code is complex and advanced computer programming skills are required to develop code in this environment. For example, a six- to eight-week training period is typical for an experienced software engineer in the request-yield-reply development paradigm described above. Much of this training period is spent appreciating the finer points of asynchronous software programming. Further, the complexity of asynchronous programming makes it an unsuitable approach for most end users who are not usually software engineers. For the most part, developers of client-server applications have accepted the development inefficiencies of the request-yield-reply program paradigm as a penalty for the additional flexibility and high interactivity of client-server applications.

There is a need for a simple, easy-to-use synchronous API that is suitable for high-level DICOM application programmers such as researchers, doctors and medical technicians. In particular, there is a need for a DICOM API that eliminates the need for the application developer to write code to handle the callback mechanism for notification of DICOM service completion. In particular, there is a need for an object-oriented database management layer comprising a class of objects having API functions that manage data asynchronously in a database, a network or an archive. The API should achieve the following: allow access to all DICOM data; handle new IODs with only changes to configuration files; represent a simplification over the raw DICOM (i.e., the API user should not need to know DICOM); and provide a useful interface to the system's major data management facilities (e.g., image store, network, archive, film).

### SUMMARY OF INVENTION

The present invention relates to an application programming interface (API) for enabling a business tier or layer of a DICOM application to talk to different implementations of a data management tier or layer. The invention has particular application in a PACS view station. In particular, the invention is directed to an API that forms the seam between a business tier or layer that requests DICOM service by synchronous messaging and a data management layer that passes on those requests to the service provider by asynchronous messaging. Thus, an application developer need not write code for the business layer that accounts for the DICOM callback mechanism, which confirms completion of a requested DICOM service. Instead the data management implementation, which is hidden from the user, handles the callback mechanism so that responses to requests for DICOM service appear instantaneous to the user.

In accordance with the preferred embodiment, the API is a collection of operations that can be invoked by the business layer for the purpose of requesting various DICOM services. The API provides an interface to a data management layer. The classes of the API are instantiated to form objects (forming an upper level of the data management layer) that communicate with underlying objects of the data management implementation. The principal classes are dmSession, dmObject and dmComposite. Each instantiation of class dmSession is an object that represents a database, network or archive (a source/sink for composites). Each instantiation of class dmObject is an object that represents an Information Entity (IE) across a collection of composites. Each instantiation of class dmComposite is an object that represents a composite in the database. Other classes will be defined below, including a class dmJob that is instantiated to create an object representing an asynchronous job. These objects are instantiated, i.e., created, at run-time and act as middlemen in communicating with underlying objects of the data management implementation. Each of the classes dmSession, dmObject and dmComposite has a corresponding peer interface for communicating with the underlying objects of the data management implementation. Different peer interfaces are provided for different data management implementations.

In accordance with the preferred embodiments, the user first creates a dmSession using new dmSession (“name”, . . . ), where “name” is the type of peer interface to create. A factory then loads the class and creates a peer session that implements the peer “dmiSession” interface. From the returned dmSession object, one can get dmObject and dmComposite. Based on the arguments received by dmSession, dmSession finds and installs the underlying objects of the data implementation by looking up in a table which underlying objects should be loaded and run. The dmSession can represent a database, a network object, an archive, etc. The data management implementation can be created in many different ways, but all of these implementations talk to the API in the same way.

Methods on dmSession, dmObject, etc. are converted to method calls on a corresponding peer interface. The peer interface is a subpackage of the data management layer. The peer package provides interfaces to the major functions of the data management implementation.

In accordance with one preferred embodiment for communicating with a simple file database, the dmSession is responsible for finding all DICOM images found in its directory, building a list of patients and composites, managing interprocess communication between multiple versions of itself in different processes, and allowing the application to “save” dmObjects to a cache. In the case of a remote database, the dmSession”s main responsibility will be to connect to the remote database. The remote database would then perform similar functions at start up.

The class dmObject encapsulates one or more DICOM IEs and provides API operations for enabling an application to obtain and transfer DICOM IEs. The dmObject communicates with the underlying objects of the implementation in accordance with a peer interface (dmiObject). In particular, the dmObject represents an IE in a collection of composites. It provides an interface to all the composites associated with that IE. The class dmObject includes operations that, when implemented as methods, provide access to collections of tag/value pairs from a representative composite; set values on composites; get related IEs; provide access to an array of BufferedImages that represent the pixel data; and provide access to a list of all composites represented by the dmObject.

The class dmComposite represents a DICOM composite file. It provides access to the file as well as caching some values as an optimization.

In accordance with the preferred embodiment, the application developer can write code for a business tier implementation that sends a synchronous request for DICOM service in the form dictated by the API. The application developer further incorporates a reusable data management layer that provides the DICOM service. For asynchronous jobs, i.e., requests for DICOM service that require a callback mechanism between a service class user and a service class provider, the callback is handled by the data management layer, not the business layer. This simplifies the application developer's task by eliminating the need to write execution code for restoring the processing context of the application to its pre-request state and then presenting the results of the operation. Instead the execution thread that requested the DICOM service simply waits until the requested information is returned. Thus, the DICOM API disclosed herein enables an application developer to write programs in less time at less cost than would otherwise be the case if the business layer of the application needed to communicate asynchronously with objects for providing DICOM service.

In accordance with the preferred embodiment, a sender object of the business layer sends a synchronous message to a target object of the data management layer, requesting a DICOM service. The execution thread of the sender object is suspended while waiting for the request to be satisfied. The instantiated object of class dmObject serves as a middleman, sending an asynchronous message to an underlying target object that provides the DICOM service. Thus, the API decouples the DICOM service object from an application object that requests DICOM service. Using this implementation, an application programmer can develop a non-blocking, highly interactive, DICOM application without having to resort to asynchronous programming techniques.

In accordance with a further aspect of the invention, the instantiated objects of class dmSession, dmObject, etc are provided with methods for caching data that will be used often. The retention of data in a cache avoids the need to repeatedly request the same information from a database. The instantiated objects of classes dmSession, dmObject etc. each further include a method for maintaining a count of the number of references to itself. A further API method removes from memory child objects that have no more references in the cache.

Other aspects of the invention are disclosed and claimed below.

### BRIEF DESCRIPTION OF DRAWINGS

FIG. 1 is a block diagram representing portions of a typical local area network for connecting DICOM-compatible medical imaging equipment.

FIG. 2 is a flowchart providing an operational overview of a prior art method for implementing a DICOM service.

FIG. 3 is a flowchart generally representing a system programmed with an application program interface for providing DICOM services in accordance with the preferred embodiment of the invention.

FIG. 4 is a sequence diagram showing process steps executed by an “init” method on the interface dmiSession during startup of a dmSession in accordance with the preferred embodiment of the invention.

FIG. 5 is a flow chart illustrating a sequence of process steps for providing synchronous execution in the business layer of an application that requests DICOM services.

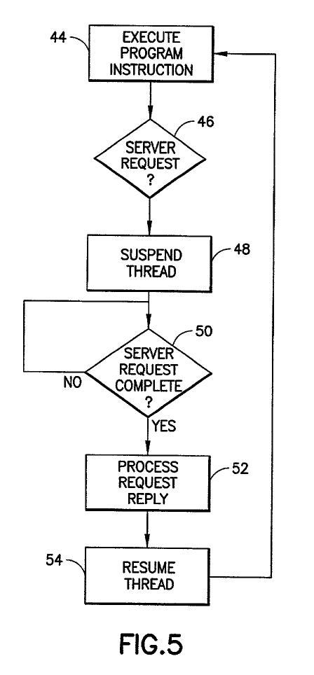

### DETAILED DESCRIPTION

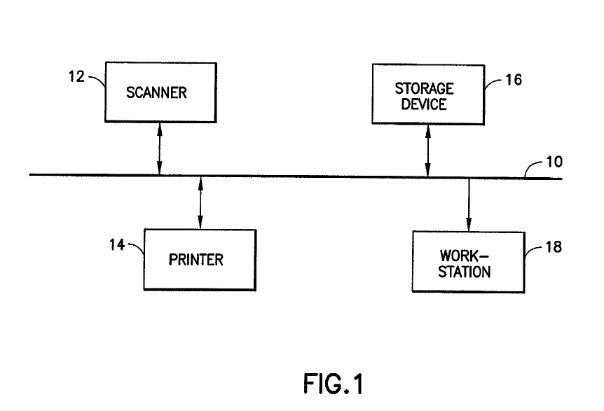

FIG. 1 generally depicts a simplified DICOM network comprising a scanner 12, a printer 14, a storage device 16, and a workstation 18, all connected to a LAN 10. As used herein, the term “storage device” includes, but is not limited to, a picture archiving and communications system (PACS) having a viewing station. It will be readily appreciated that this diagram represents a simplified example of a DICOM network and that an actual DICOM network in the real world will have many more devices connected to the LAN, including scanners of different modalities. The API disclosed herein is preferably implemented on a PACS workstation, but may be implemented on other computerized devices, including but not limited to scanners.

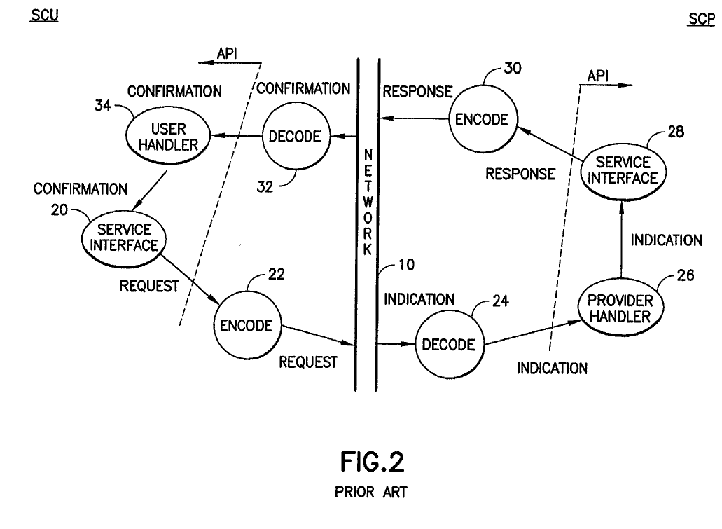

FIG. 2 depicts an example of a prior art operational scenario for implementing the services and protocol of the DICOM standard using an object-oriented DICOM toolkit. A complete description of this prior art API can be found in U.S. Pat. No. 5,668,998. However, a brief description will be given here in order to establish a reference for the present invention. In accordance with the software shown in FIG. 2, The dashed lines (labeled “API”) indicate the seam between an application and DICOM service collection of objects. First, a service interface object 20 initiates a request. The outgoing message is called a “Request”. The request is encoded (step 22) into a DICOM message. This involves two processes. First, the message is formulated into the DICOM toolkit's own internal representation, called an “element list”. Each individual attribute to be included in the message is represented in this list. The elements in the list are then each dumped into packets specified by the DICOM protocol. These packets are then transmitted across an LAN 10 to a DICOM service provider.

The incoming packets are decoded (step 24) by the service provider and an element list identical to the one that was transmitted is created. The incoming message is called an “Indication”. The decoding process determines the message type. This information is used to route the message to the correct provider handler 26. A single provider handler is responsible for only those messages associated with a particular service. There are provider handlers for storage, verification, print, etc. The provider handler 26 routes the indication to a service interface object 28 of the service provider. The provider handler represents the division between the API layer of the toolkit and the internal software. The provider handler is responsible for either routing the message to an existing service interface object, or creating a new service interface object of the appropriate type and then routing the message on. The service interface object 28 on the service provider side of the network is responsible for performing any actions that the application determines is necessary to perform the actual DICOM service. Part of the default responsibilities of the service interface object 28 is to send an acknowledgment back to the service user side of the network. This outgoing message is called a “Response”. As on the user side of the network, the response is encoded (step 30) into a DICOM message on the provider side of the network. Packets are transmitted across the network 10 to the DICOM service user. The incoming packets are decoded (step 32) by the service user. The incoming message is called a “Confirmation”. The decoding process determines the message type. This information is used to route the message to the correct user handler 34. The user handler 34 is responsible for being able to route the confirmation to the service interface object that initiated the request. A single user handler is responsible for only those messages associated with a particular service, i.e., there will be user handlers for storage, verification, print, etc. The service interface object 20 on the service user side of the network is now responsible for performing any actions that the application determines is necessary to cleanup the transaction. At this point in time, the confirmation has been received, so the transaction is considered complete.

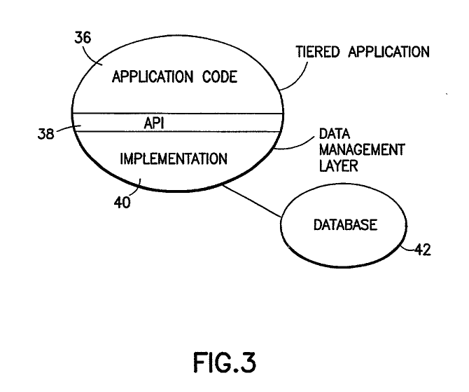

In contrast to the software shown in FIG. 2, wherein the asynchronous callback mechanism extends across the API, the present invention (generally depicted in FIG. 3) provides an API 38 that decouples the business layer 36 of a tiered application from the asynchronous environment of a DICOM data management implementation 40 that manages the DICOM data in database 42. The classes of the API are instantiated to form objects that communicate a synchronously with underlying objects of the data management implementation. The principal classes are dmSession, dmObject and dmComposite. The API 38 specifies a contract for these and other classes without dictating their implementation 40. Each class provides a set of methods that properly implement the operations defined in the interface. Each instantiation of class dmSession is an object that represents a database, network or archive (a source/sink for composites). Each instantiation of class dmObject is an object that represents an Information Entity (IE) across a collection of composites. Each instantiation of class dmComposite is an object that represents a composite in the database.

In accordance with the preferred embodiments, the user first creates a dmSession using new dmSession (“name”, . . . ), where “name” is the type of peer interface to create. A factory then loads the class and creates a peer session that implements the peer “dmiSession” interface. From the returned dmSession object, one can get dmObject and dmComposite. Based on the arguments received by dmSession, the constructor DMSession finds and installs the underlying objects of the data implementation by looking up in a table which underlying objects should be loaded and run. The dmSession can represent a database, a network object, an archive, etc. The data management implementation can be created in many different ways, but all of these implementations talk to the API in the same way.

Constructor DMSession (java.lang.String type, java.lang.String rep, java.lang.String [ ] args) will construct a session of a specific type. The Parameters “type”, “rep” and “args” are respectively the type of session (typically “file” or “terra”), the basic repository for “file” is its directory and for “terra” is the “terra” database, and additional arguments needed for the database.

In accordance with one preferred embodiment for communicating with a simple file database, the dmSession is responsible for finding all DICOM images found in its directory, building a list of patients and composites, managing interprocess communication between multiple versions of itself in different processes, and allowing the application to “save”dmObjects to a cache. In the case of a remote database, the dmSession”s main responsibility will be to connect to the remote database. The remote database would then perform similar functions at start up.

The class dmSession in accordance with the preferred embodiment of the invention includes the following methods: insertSession( ) is used to insert new classes in a session; getComposite (byte[ ] id) returns a list of all composites in the system; getComposites( ) returns all composites in the system; getNumberOfComposites( ) returns the number of composites in the system; GetChildren( ) gets an array of all children (patients) in the system; GetChildren (DMQuery q) gets a list of all patients in a system that match a query; getRelated ava.lang.String ieType) gets all related IEs (the parameter ieType would be one of “Study”, “Series”, “Image”); getRelated (java.lang.String ieType, DMQuery q) gets all related IE types that conform to the appropriate IE; getDMObject (java.lang.String type, jave lang.String id) returns an array of dmObjects given an ID; getProperty (java.lang.String key) returns a value; setProperty (java.lang.String key, java.lang.Object value) sets a value; ClearCache( ) clears cached data; AllocateMemory( ) allocates memory; installFiles( ) allows the user to insert a DICOM file into the database; save( ) will transfer an object or composite from one repository to another; addDMEventListener(int eventType, DMEventListener listener) adds an event listener of eventType to be notified (usually used to inform clients of events; the parameter “listener” is the “callback” object); and send (java.lang.String str) can be used to send objects from one process to another (many if not all dmSessions have the ability to create and specify objects as strings; these strings can be used to send objects from one process to another).

In accordance with the preferred embodiment, dmSession inherits methods from a class java.lang.Object. The methods inherited from class java.lang.Object include clone, equals, finalize, getClass, hashCode, notify, notifyAll, toString, and wait. These methods are hidden to the user.

The class dmObject encapsulates one or more DICOM IEs and provides API operations for enabling an application to obtain and transfer DICOM IEs. The dmObject communicates with the underlying objects of the implementation in accordance with a peer interface (dmiObject). In particular, the dmObject represents an IE in a collection of composites. It provides an interface to all the composites associated with that IE. The class dmObject includes operations that, when implemented as methods, provide access to collections of tag/value pairs from a representative composite; set values on composites; get related IEs; provide access to an array of BufferedImages that represent the pixel data; and provide access to a list of all composites represented by the dmObject.

The class dmObject in accordance with the preferred embodiment of the invention includes the following methods: delete( ) is used to delete the object and any of its composites; equals (java.lang.Object obj) checks if the two peers are the same; finalize( ) returns a string that will uniquely identify the object to the session;; GetComposites( ) returns all composites associated as dmObject with this DICOM (IE based) object; getPixelData( ) gets buffered images from the object (each frame in each composite is returned as an array of buffered images; getRelated ava.lang.String ieType) gets all related IEs (the parameter ieType would be one of “Study”, “Series”, “Image”); getRelated (java.lang.String ieType, DMQuery q) returns all related IE types that conform to the appropriate IE; getNumberOfRelated (java.lang.String ieType) gets the number of related IEs; getType( ) returns the IE type of this object as a string; getValue (DMTag t) returns the value of a tag found in one of the composites associated with this DICOM object. The methods inherited from class java.lang.Object include clone, getClass, hashCode, notify, notifyAll, toString, and wait.

The class dmComposite represents a DICOM composite file. It provides access to the file as well as caching some values as an optimization. The class dmComposite in accordance with the preferred embodiment of the invention includes the following methods: delete, getType, getValue, getPixelData.

In accordance with the preferred embodiment, each object of class dmQuery represents a query; each object of class dmTag represents a tag; each object of class dmIOD represents an IOD or composite IOD; each object of class dmEvent represents an event; and each object of class dmJob represents an asynchronous job.

Each of the classes dmSession, dmObject and dmComposite has a corresponding peer interface (dmiSession, dmObject, dmComposite) for communicating with the underlying objects of the data management implementation. Different peer interfaces are provided for different data management implementations. Methods on dmSession, dmObject, etc. are converted to method calls on a corresponding peer interface. The peer interface is a subpackage of the data management layer. The peer package provides interfaces to the major functions of the data management implementation.

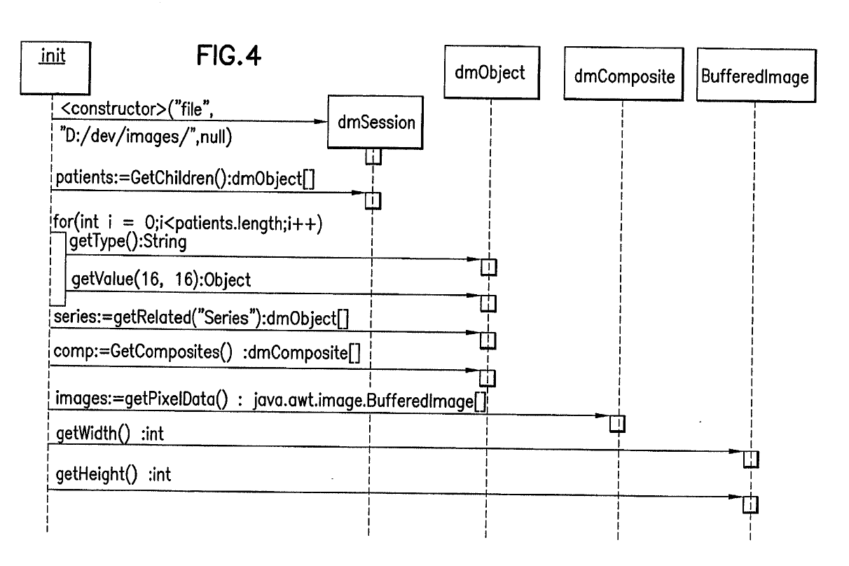

FIG. 4 shows a series of messages sent during startup in accordance with the preferred embodiment of the invention. The user first creates a new dmSession using new dmSession (“name”, . . . ), where “name” is the type of peer to create. The factory creates a peer session that implements the peer dmiSession interface. From the returned dmSession object, one can get dmObject and dmComposite. When a call like getChildren( ) is made, it returns an array of dmiObjects (the interfaces). This is then converted to an array of dmObjects by calls to: new dmObject (dmiObject in), which install the interface. The composites are gotten by sending the GetComposites message to dmObject. The buffered images are gotten by sending the getPixelData message to dmComposite.

In the case where the implementation of the data management layer is a database based on a directory of files, the dmSession is responsible for implementing the dmiSession interface; finding all DICOM images in its directory; building the list of patients and composites; managing interprocess communication between multiple versions of itself in different processes; and allowing the application to “save” dmObjects to dmSession. The startup of a dmSession invokes an “init” on the interface dmiSession that causes the fileSession init method to be called. The init method comprises the following steps: (1) recursively descends the given directory and finds all DICOM files; (2) creates a dmComposite for each DICOM file (the dmComposite object parses the DICOM file and caches some of the relevant fields); and (3) builds a list of patients. In the case of a remote database, dmSession's main responsibility will be to connect to the remote database in accordance with the DICOM protocol. The remote database would then perform similar functions at startup.

Returning to FIG. 3, the API 38 decouples the asynchronous data management layer 40 from the synchronous business layer 36 in the tiered application. All methods needed for asynchronous DICOM communication are hidden in the dmSession, dmObject and dmComposite objects. The application developer need not concern him/herself with writing code that registers the callback function. The asynchronous messaging and callback registration functions embedded in dmSession, dmObject and dmComposite are hidden from the user and allow the application developer to write application code that executes synchronously. FIG. 7 is a flowchart illustrating a sequence of process steps for providing synchronous execution of a request for DICOM service made by a user. A program thread of instructions is executed (step 44). For those commands that require sending a request to a DICOM service provider, i.e., a server request 46, the execution thread of application is suspended (step 48), meaning that the execution thread waits while the request is being satisfied. The request for DICOM service may be in the form of one of the operations defined above for classes dmSession, dmObject and dmComposite. The application execution thread waits while the object-oriented data management layer provides the DICOM service asynchronously. The execution thread waits until the service request is completed (step 50). The reply to the request for DICOM service is processed (step 52) and then the application execution thread is resumed (step 54).

In accordance with the preferred embodiment of the invention, the code for the business layer of the application code is synchronous, highly readable, compact and can be developed by a practitioner not familiar with programming in a client-server architecture. All asynchronous communications between the DICOM service class user and service class provider are managed by the data management layer of the application code. The API disclosed herein forms the seam between the synchronous business layer and the asynchronous data management layer. Because of no callbacks, the application code follows a simple, uninterrupted flow. Instead of, e.g., asking for children, registering a callback to handle the request, going into a wait state, and making sure the callback has the correct parameters, the application just makes one call and the data is returned via the parameters in that one call.

In accordance with a further aspect of the invention, the classes dmSession, dmObject and dmComposite are implemented with hidden methods that enable reference counting within each object. The primary quality variables for the reference counting function are the following: (1) the Java developer should not need to implement manual garbage collection; (2) the Java can clean up a large collection of data that may accumulate as a result of queries; and (3) the system can cache data that will be used often.

The basic premise is that the DICOM user is working with a potential tree of IODs or Composite IODs. The nodes of the tree are built by querying, e.g., using the method GetChildren. If the system does not cache the requested objects and the relations between objects, then every traversal of the tree (up or down) would require that a request be sent to the database. In accordance with the preferred embodiment of the invention, such repeated recourse to the database is avoided by caching data in dmSession. Similarly, data is cached in dmObject and dmComposite. Thus, the application developer need not implement the cache.

In accordance with the preferred embodiment, a reference counting function is provided to facilitate utilization of the cache embedded in each object. The central concepts of the reference counting function are as follows: (1) the GetChildren command can access information more quickly if the information is loaded in a cache in system RAM (as opposed to requesting from a remote or local database; and (2) the application developer can request cleanup of variable nodes in the tree. In the preferred implementation, each dmSession contains the following: (a) a pointer to all children it has found in response to a GetChildren( ) request; (b) an AllChildren flag that indicates whether the dmSession has all children; and (c) a reference count of the number of references to itself. The tree of objects maintains these references so that it can repeatedly hand out pointers to the same objects and manage its use of memory. Objects also have a CleanUpChildren( ) function that removes children that have no more references. The functions incr_ref( ) and decr_ref( ) adjust the reference counter. For instance, the GetChildren( ) function will call the incr_ref( ) function for all children returned. [Note: If GetChildren sees the AllChildren flag, it does not have to go to the database.] The finalize method calls decr_ref. This causes the reference counter to decrease whenever the Java gives up a pointer to the class.

To understand how reference counting will cache data, it is useful to consider the following example. If at a Study level, the user descends a tree to get all images and display them, the cache will contain references to the related series (all cached). The next time the user gets a listing of a series under the study to fill a table widget [Note: a “table widget” is a graphical user interface component that allows the display of a table of data.] showing all the series, the cache will display the series without going back to the database. If the cache were not maintained, the user would then need to maintain a list of all series. Then the table widget could not be used because it would just take the study and query for the series. The entire application would then be greater in size and more prone to memory leaks.

While the invention has been described with reference to preferred embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

As used in the claims, the term “computer system” is used broadly to include a single computer or data processor, or a group of interconnected computers or data processors. As will be readily appreciated by persons skilled in the art, two related data processing functions can be implemented as executable code on separate but connected computers or on the same computer. The object-oriented terminology appearing in the claims has the meanings adopted in the Unified Modeling Language. For example, the term “synchronous message” means a message whose sender object must suspend execution while the message is being processed by a target object, whereas the term “asynchronous message” means a message whose sender object may continue to execute while the message is being processed by the target object.

1. A computer system having a tiered application comprising a business layer and an object-oriented data management layer that communicate via an application programming interface, and a database containing DICOM data that is managed by said data management layer, wherein an implementation of said business layer comprises code for requesting DICOM service via a synchronous message, and an implementation of said data management layer comprises code for providing DICOM service in response to said request, wherein said code in said data management layer employs asynchronous messaging to accomplish DICOM callback.

2. The computer system as recited in claim 1, wherein said data implementation layer is distributed on first and second computers connected via a network.

3. The computer system as recited in claim 1, wherein said database is based on a directory of DICOM files.

4. The computer system as recited in claim 1, wherein said data management layer implementation comprises an initialization method for constructing, at runtime, underlying objects of said data management layer implementation, said underlying objects being a function of the type of database to be managed.

5. The computer system as recited in claim 4, wherein said database comprises DICOM files.

6. The computer system as recited in claim 4, wherein said database comprises an archive.

7. The computer system as recited in claim 4, wherein said database comprises a network object.

8. The computer system as recited in claim 1, wherein said implementation of said data management layer comprises objects of a class having a method for counting the number of references to each object.

9. The computer system as recited in claim 8, wherein said objects have a method for caching references.

10. The computer system as recited in claim 9, wherein implementation of said data management layer comprises objects of a session class having a method for clearing a cache in response to a message from said implementation of said business layer.

11. The computer system as recited in claim 9, wherein said objects have a method for removing children that have no references.

12. A method for writing a DICOM application, comprising the step of writing code for a business layer of a tiered application, said code sending synchronous messages that conform to a pre-existing application programming interface when DICOM service is requested by a user.

13. A workstation for viewing DICOM images, comprising a computer, a display monitor and an operator interface, wherein said computer is programmed with a tiered application comprising an object-oriented implementation of a data management layer that handles DICOM callbacks in response to requests for DICOM service having a format required by an application programming interface.

14. The workstation as recited in claim 13, wherein said implementation of said data management layer comprises code for sending asynchronous messages requesting DICOM service and said request is in the format of a synchronous message.

15. The workstation as recited in claim 13, wherein said implementation of said data management layer comprises objects of a class having a method for counting the number of references to each object.

16. The workstation as recited in claim 15, wherein said objects have a method for caching references.

17. The workstation as recited in claim 16, wherein said implementation of said data management layer comprises objects of a session class having a method for clearing a cache in response to an input to said operator interface.

18. The workstation as recited in claim 16, wherein said objects have a method for removing children that have no references.

19. A computer system comprising a database containing DICOM data and a tiered application, wherein said tiered application comprises:
a first tier comprising code for requesting a DICOM service by sending a synchronous message in a format conforming to an application programming interface; and
a second tier comprising code for managing said database to provide DICOM service in response to receipt of said request, wherein said code for managing said database sends asynchronous messages that implement a DICOM callback mechanism,
wherein said application programming interface represents a seam between said first tier code and said second tier code.

20. A computer network comprising a service class user and a service class provider connected via a local area network, a database accessible by said service class provider, and a tiered application distributed between said service class user and said service class provider, wherein said tiered application comprises:
a first tier comprising code for requesting a DICOM service by sending a synchronous message in a format conforming to an application programming interface; and
a second tier comprising code for managing said database to provide DICOM service in response to receipt of said request, wherein said code for managing said database sends asynchronous messages that implement a DICOM callback mechanism,
wherein said application programming interface represents a seam between said first tier code and said second tier code.
